(19) United States
(12) Patent Application Publication
(10) Pub. No.: US 2026/0249926 A1
(43) Pub. Date: Aug. 27, 2026

(54) VEHICLE BODY STRUCTURE

(71) Applicant: Honda Motor Co., Ltd., Tokyo (JP)

(72) Inventors: Yuya KAWANO, Tokyo (JP); Yamato SASANO, Tokyo (JP); Masahiro ABIKO, Tokyo (JP)

(73) Assignee: Honda Motor Co., Ltd., Tokyo (JP)

(21) Appl. No.: 19/455,870

(22) Filed: Jan. 22, 2026

(30) Foreign Application Priority Data
Feb. 25, 2025 (CN) 202510211873.5

(51) Int. Cl. B62D 25/14; B62D 25/20

(52) U.S. Cl. CPC B62D 25/14; B62D 25/2018

(57) ABSTRACT

The vehicle body structure includes: a dashboard lower panel, partitioning cabin-interior and cabin-exterior regions; a side frame; a front frame, disposed in the interior region opposite to a rear region of the side frame in the cabin-exterior region, with the dashboard lower panel intervening; inner and outer cross members, extending inward and outward respectively from the front frame in a vehicle width direction; and inner and outer reinforcing ribs, extending inward and outward respectively from the rear region of the side frame in the vehicle width direction. The front frame, the inner cross member, and the outer cross member form a triple fork structure. The ribs form a double fork structure. The inner cross member and the inner reinforcing rib are opposite with the dashboard lower panel intervening, the outer cross member and the outer reinforcing rib are opposite with the dashboard lower panel intervening.

### CROSS-REFERENCE TO RELATED APPLICATION

This application claims the priority benefit of China application serial no. 202510211873.5, filed on February 25, 2025. The entirety of the above-mentioned patent application is hereby incorporated by reference herein and made a part of this specification.

### BACKGROUND

### TECHNICAL FIELD

The disclosure relates to a vehicle body structure.

### DESCRIPTION OF RELATED ART

In recent years, efforts to provide access to sustainable transportation systems that also consider vulnerable people among traffic participants, such as the elderly, disabled, or children, are becoming active. For such purpose, research and development are being conducted to further improve traffic safety and convenience through development related to collision safety performance.

For example, in the conventional art (e.g., Chinese Patent Publication No. 118457737), in a vehicle body structure formed by structures such as a dashboard lower panel, a floor panel, a side member, etc., a front frame extending in the vehicle front-rear direction and a cross member extending in the vehicle width direction and intersecting and connected with the front frame are provided on the upper side of the floor panel to transmit or spread collision loads. However, how to effectively transmit collision loads of the vehicle body structure at the time of collision and locally reinforce components on the load transmission path still require efforts.

The disclosure provides a vehicle body structure that enables favorable load transmission performance and enables local reinforcement on components on the load transmission path, thereby improving collision safety performance, and making contributions to the development of sustainable transportation systems.

### SUMMARY

According to an embodiment of the disclosure, a vehicle body structure includes: a dashboard lower panel, disposed on a front end side of the vehicle body structure and partitioning a cabin-interior region and a cabin-exterior region of a compartment; a side frame, extending along a vehicle length direction in a front compartment located in the cabin-exterior region; a front frame, disposed in the cabin-interior region to be opposite to a rear region of the side frame with intervention of the dashboard lower panel, and extending in the vehicle length direction along the dashboard lower panel; an inner cross member, extending inward from the front frame in a vehicle width direction; an outer cross member, extending outward from the front frame in the vehicle width direction; an inner reinforcing rib, extending inward from the rear region of the side frame in the vehicle width direction; and an outer reinforcing rib, extending outward from the rear region of the side frame in the vehicle width direction. In the cabin-interior region, the front frame, the inner cross member, and the outer cross member form a triple fork structure. In the cabin-exterior region, the inner reinforcing rib and the outer reinforcing rib form a double fork structure. The inner cross member and the inner reinforcing rib are disposed to be opposite via the dashboard lower panel, and the outer cross member and the outer reinforcing rib are disposed to be opposite with intervention of the dashboard lower panel.

### BRIEF DESCRIPTION OF THE DRAWINGS

FIG. 1 and FIG. 2 are schematic perspective views illustrating a vehicle body structure according to an embodiment of the disclosure from different viewing angles.

FIG. 3 is a partially enlarged schematic view illustrating a double fork structure of the vehicle body structure shown in FIG. 1.

FIG. 4 is a schematic cross-sectional view illustrating the vehicle body structure shown in FIG. 1 along a line A-A.

FIG. 5 is a partially enlarged schematic view of a triple fork structure of the vehicle body structure shown in FIG. 1.

FIG. 6 is a schematic cross-sectional view illustrating the vehicle body structure shown in FIG. 1 and FIG. 5 along a line B-B.

FIG. 7 is a schematic cross-sectional view illustrating the vehicle body structure shown in FIG. 1 and FIG. 5 along a line C-C.

### DESCRIPTION OF THE EMBODIMENTS

According to an embodiment of the disclosure, a vehicle body structure includes: a dashboard lower panel, disposed on a front end side of the vehicle body structure and partitioning a cabin-interior region and a cabin-exterior region of a compartment; a side frame, extending along a vehicle length direction in a front compartment located in the cabin-exterior region; a front frame, disposed in the cabin-interior region to be opposite to a rear region of the side frame with intervention of the dashboard lower panel, and extending in the vehicle length direction along the dashboard lower panel; an inner cross member, extending inward from the front frame in a vehicle width direction; an outer cross member, extending outward from the front frame in the vehicle width direction; an inner reinforcing rib, extending inward from the rear region of the side frame in the vehicle width direction; and an outer reinforcing rib, extending outward from the rear region of the side frame in the vehicle width direction. In the cabin-interior region, the front frame, the inner cross member, and the outer cross member form a triple fork structure. In the cabin-exterior region, the inner reinforcing rib and the outer reinforcing rib form a double fork structure. The inner cross member and the inner reinforcing rib are disposed to be opposite via the dashboard lower panel, and the outer cross member and the outer reinforcing rib are disposed to be opposite with intervention of the dashboard lower panel.

According to an embodiment of the disclosure, the vehicle body structure includes a central section formed by the front frame and the dashboard lower panel. A power unit is provided in a region behind the double fork structure and below the central section.

According to an embodiment of the disclosure, in the triple fork structure, the front frame protrudes toward the cabin-interior region to form a central protrusion extending along the vehicle length direction, the inner cross member protrudes toward the cabin-interior region to a same extent as the central protrusion and forms an inner protrusion extending inward and rearward along the vehicle width direction, and the outer cross member protrudes toward the cabin-interior region to a same extent as the central protrusion and forms an outer protrusion extending outward and rearward along the vehicle width direction. When observed from a top perspective, the central protrusion, the inner protrusion, and the outer protrusion extend in different directions, respectively.

According to an embodiment of the disclosure, when viewed from a bottom perspective, in the double fork structure, the inner reinforcing rib and the outer reinforcing rib and the central protrusion of the triple fork structure extend in different directions, respectively, and the inner reinforcing rib and the outer reinforcing rib form a fork part exhibiting a fork shape at a position overlapping with the front frame in a vehicle height direction.

According to an embodiment of the disclosure, the vehicle body structure further includes: a floor panel, connected to a rear end of the dashboard lower panel; and a floor channel, disposed at a center of the dashboard lower panel and the floor panel in the vehicle width direction and extending along the vehicle length direction. The inner cross member includes a channel connection part and a flange connection part. The channel connection part is connected to a side surface part of the floor channel. The flange connection part is connected to the floor channel and the dashboard lower panel. In a rear region of the inner protrusion part, the channel connection part and the flange connection part form an L-shaped section.

According to an embodiment of the disclosure, a closed section formed by the inner protrusion and the dashboard lower panel and a closed section formed by the inner reinforcing rib and the dashboard lower panel are disposed to be staggered in the vehicle length direction.

According to an embodiment of the disclosure, the vehicle body structure further includes: an abutting component, protruding toward the cabin-interior region. The abutting component is disposed to span across the inner protrusion in the vehicle length direction. The abutting component is disposed above the closed section formed by the inner reinforcing rib and the dashboard lower panel.

According to an embodiment of the disclosure, a closed section formed by the outer protrusion and the dashboard lower panel and a closed section formed by the outer reinforcing rib and the dashboard lower panel are disposed to be opposite to each other to form an outer closed section.

According to an embodiment of the disclosure, the vehicle body structure further includes: a side member, extending along the vehicle length direction; and a front pillar, extending upward from a front end of the side member. The outer cross member further includes: a front connection part, arranged as a portion of the outer protrusion connected to at least one of the side member and the front pillar; a bent protrusion, extending from a center of the outer protrusion in the vehicle width direction along the vehicle length direction, a rear region of the bent protrusion being bent toward the side member; and a rear connection part, extending from the bent protrusion toward and be connected to a side surface of the side member.

According to an embodiment of the disclosure, the vehicle body structure further includes: a fixing bracket, provided above the triple fork structure and configured to fix articles on a vehicle. In an upper region of a connection part where the side frame and the front frame are connected to each other via the dashboard lower panel, the fixing bracket and the front frame are connected.

Based on the above, in the embodiment of the disclosure, the vehicle body structure is provided with a triple fork structure in the cabin-interior region that forms the vehicle interior space where the occupants take seats, and is provided with a double fork structure in the front compartment located in the cabin-exterior region. The triple fork structure includes the front frame and the inner cross member and the outer cross member that extend inward and outward respectively from the front frame in the vehicle width direction, and the double fork structure includes the inner reinforcing rib and the outer reinforcing rib that extend inward and outward respectively from the rear region of the side frame in the vehicle width direction. Moreover, through the configuration where the inner cross member of the triple fork structure and the inner reinforcing rib of the double fork structure are disposed to be opposite with intervention of the dashboard lower panel and the outer cross member of the triple fork structure and the outer reinforcing rib of the double fork structure are disposed to be opposite with intervention of the dashboard lower panel, compared with the structure of the section formed by the dashboard lower panel and the cross member as the load transmission path in the prior art, the vehicle body structure may adopt the sections formed by the triple fork structure and the double fork structure as the load transmission paths, thereby increasing the area of the section for transmitting the collision load and improving the load transmission performance at the time of collision. Furthermore, unlike the conventional dashboard lower panel made of a thin plate, in the vehicle body structure of the disclosure, the plate thickness and the material rigidity of the outer reinforcing rib and inner reinforcing rib of the double fork structure located in the cabin-exterior region may be adjusted, and the plate thickness and the materials may be selected based on the requirements of regions that need reinforcement, thereby enabling local reinforcement on regions of the load transmission path. In this way, when encountering a severe collision situation, the requirement for transmitting a larger collision load may also be realized through the double fork structure without having to reinforce the entire vehicle body structure, and the needs for reducing the product cost and weight can be addressed at the same time.

Reference will now be made in detail to exemplary embodiments of the disclosure, examples of the exemplary embodiments are illustrated in the accompanying drawings. Wherever possible, the same reference numerals will be used throughout the drawings and the description to refer to the same or like parts.

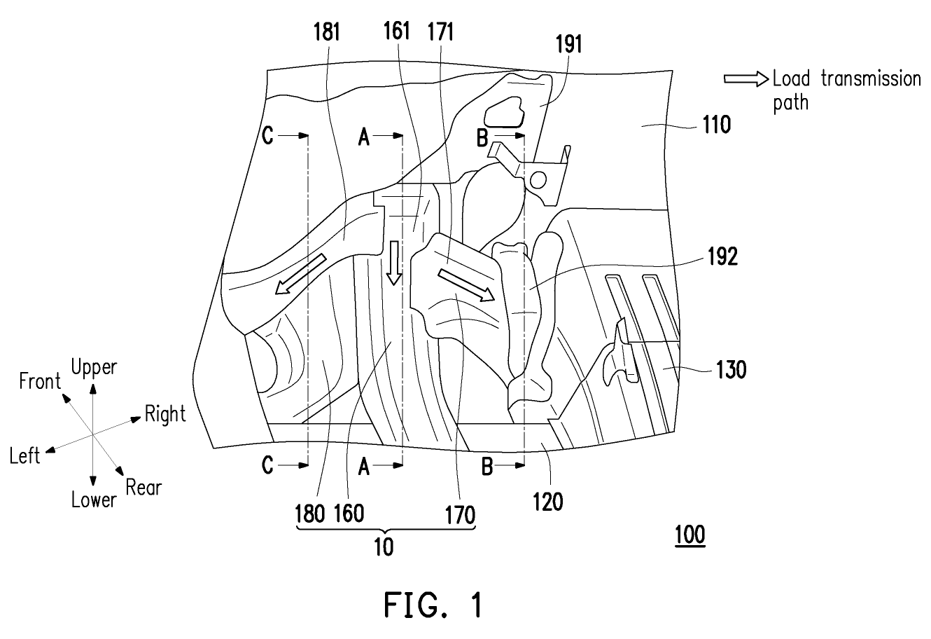

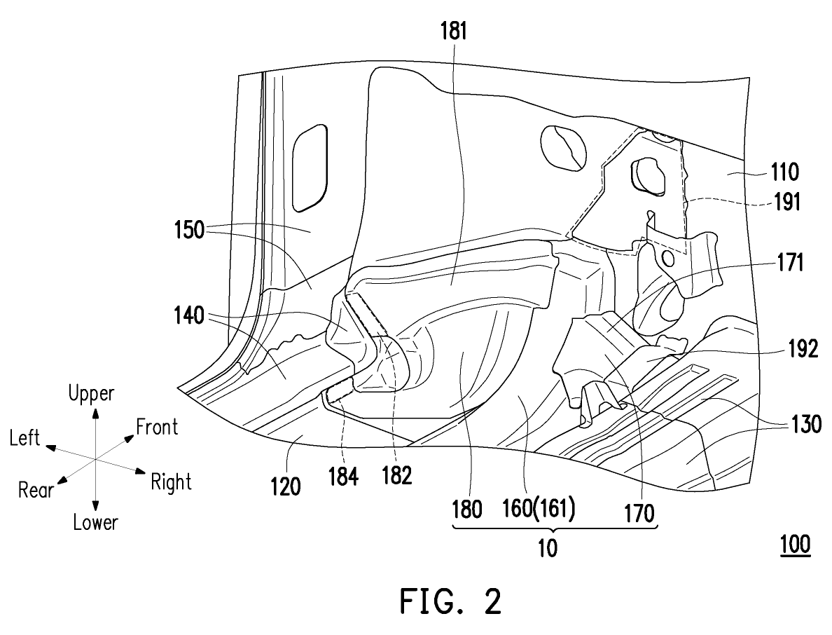

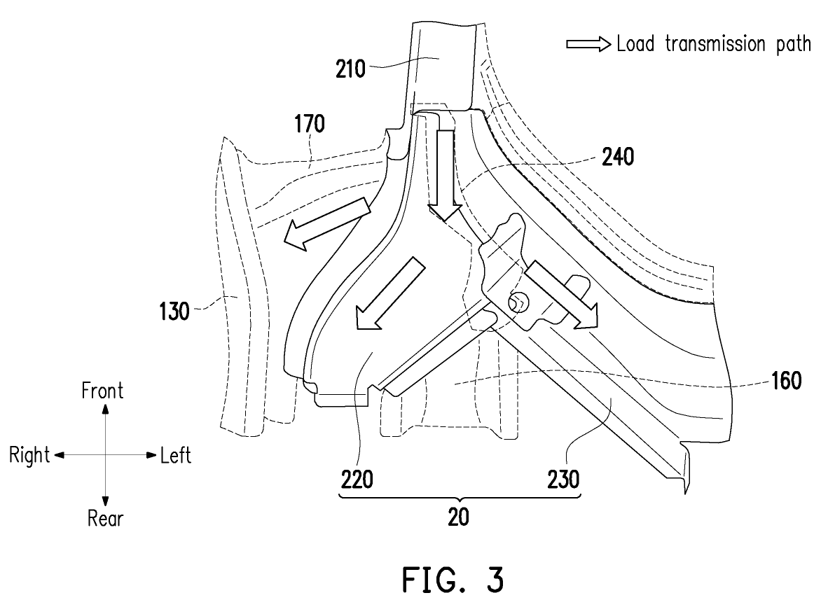

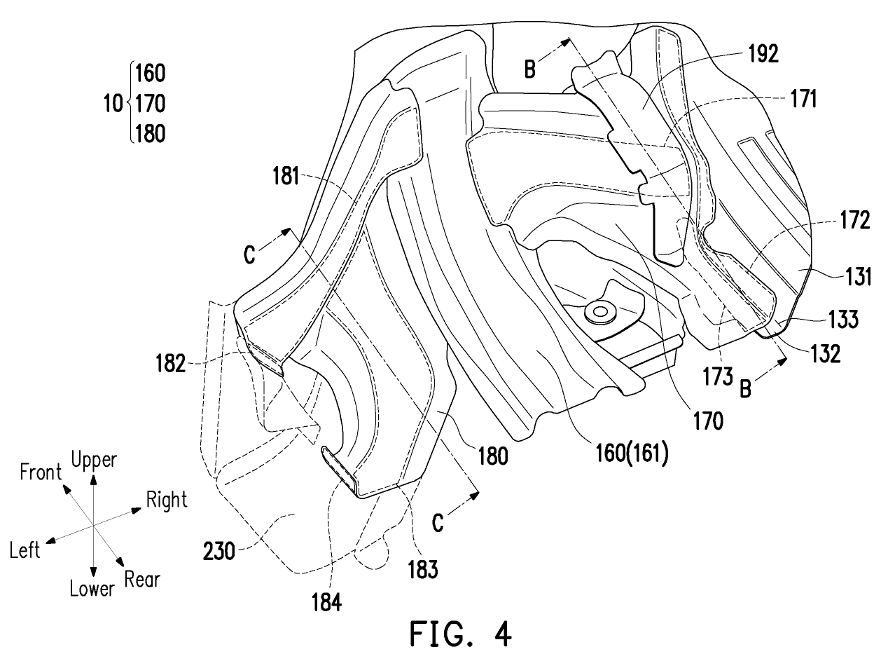

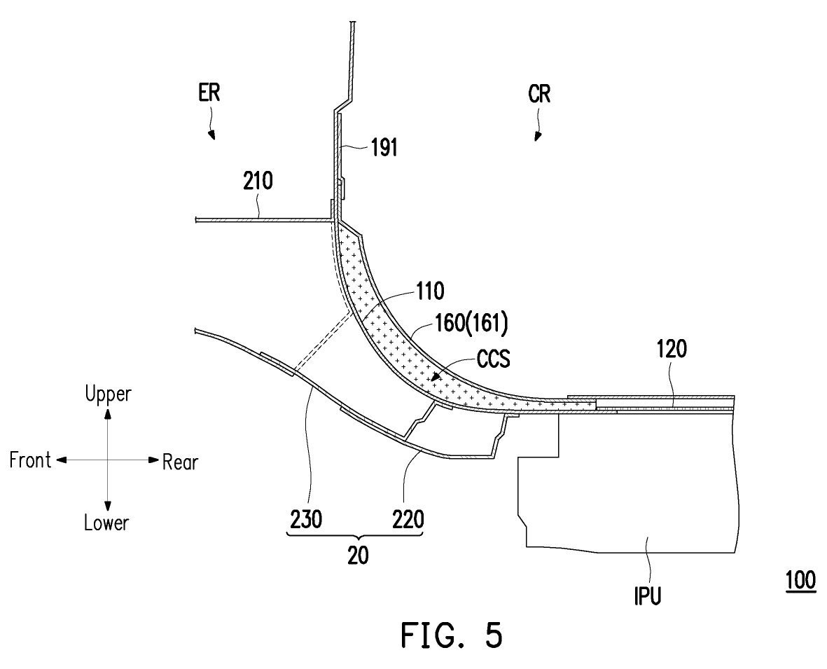

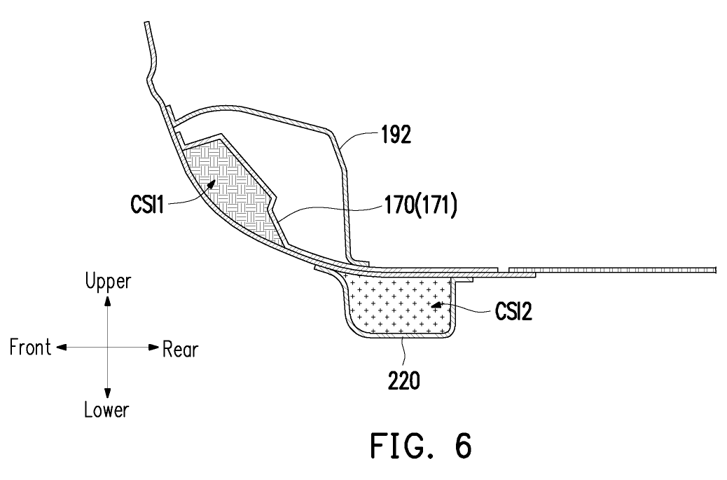

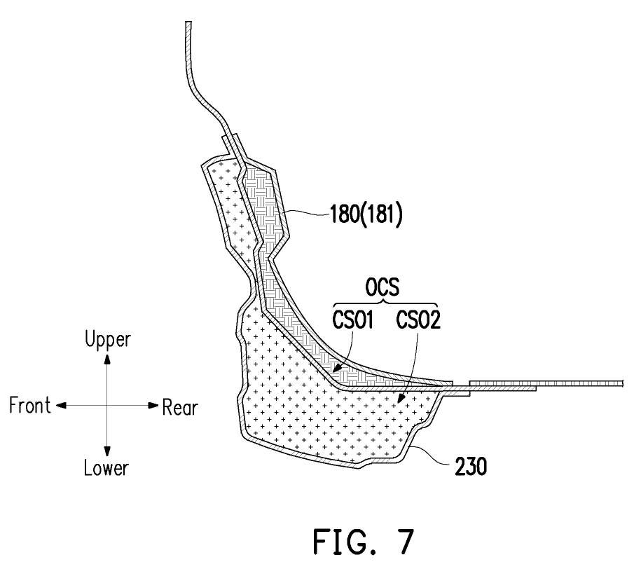

FIG. 1 and FIG. 2 are schematic perspective views illustrating a vehicle body structure according to an embodiment of the disclosure from different viewing angles. FIG. 3 is a partially enlarged schematic view illustrating a double fork structure of the vehicle body structure shown in FIG. 1. FIG. 4 is a schematic cross-sectional view illustrating the vehicle body structure shown in FIG. 1 along a line A-A. FIG. 5 is a partially enlarged schematic view of a triple fork structure of the vehicle body structure shown in FIG. 1. FIG. 6 is a schematic cross-sectional view illustrating the vehicle body structure shown in FIG. 1 and FIG. 5 along a line B-B. FIG. 7 is a schematic cross-sectional view illustrating the vehicle body structure shown in FIG. 1 and FIG. 5 along a line C-C. In this embodiment, the vehicle body structure refers to a vehicle body structure located near a dashboard lower panel in the vehicle. It should be noted that, for convenience, the front-rear direction, the left-right direction, and the upper-lower direction of the vehicle are defined as shown in the figures, and the configuration of each part is described according to this definition. In addition, the front-rear direction, the left-right direction, and the upper-lower direction of the vehicle respectively correspond to the vehicle length direction, the vehicle width direction, and the vehicle height direction. pillars 150, front frames 160, inner cross members 170, outer cross members 180, side frames 210, inner reinforcing ribs 220, and outer reinforcing ribs 230. Specifically, as shown in FIG. 1, FIG. 2, and FIG. 4, in this embodiment, the dashboard lower panel 110 is disposed on the front end side of the vehicle body structure 100 and partitions a passenger compartment CR and a front compartment ER, the cabin-interior region in the passenger compartment CR is a vehicle interior space where occupants take seats, and the front compartment ER is located in the cabin-exterior region excluding the vehicle interior space where occupants take seats. The floor panel 120 is disposed on the lower end side of the vehicle body structure 100 and connected to the rear end of the dashboard lower panel 110. The floor channel 130 is disposed at the center of the dashboard lower panel 110 and the floor panel 120 in the vehicle width direction, and extends along the vehicle length direction. Moreover, as shown in FIG. 2, in this embodiment, the side members 140 are set on both sides of the floor panel 120 in the vehicle width direction, and the side members 140 extend along the vehicle length direction, and the front pillars 150 extend upward from the front ends of the side members 140.

Referring to FIG. 1 to FIG. 7, in the embodiment, a vehicle body structure 100 includes a dashboard lower panel 110, a floor panel 120, a floor channel 130, side members 140, front Meanwhile, as shown in FIG. 1, FIG. 3, and FIG. 4, in this embodiment, the side frame 210 extends along the vehicle length direction within the front compartment ER located in the cabin-exterior region, and the front frame 160 is disposed within the cabin-interior region to be opposite to the rear region of the side frame 210 with intervention of the dashboard lower panel 110, and extends along the dashboard lower panel 110 in the vehicle length direction between the side member 140 and the floor channel 130. That is, the front frame 160 and the side frame 210 are arranged side by side in the vehicle length direction to sandwich the dashboard lower panel 110. Specifically, as shown in FIG. 5, the front frame 160 and the side frame 210 at least partially overlap, so that the side frame 210 is located at substantially the same horizontal height as the front frame 160 and corresponds to each other, so the rear side of the side frame 210 may be supported via the front frame 160 to suppress the collapse of the dashboard lower panel 110 caused by the intrusion of the side frame 210 toward the vehicle interior side (i.e., the rear side) at the time of collision. However, the disclosure does not limit the specific structure of the side frame 210 and the relative position between the side frame 210 and the front frame 160, which may be adjusted as needed.

Furthermore, as shown in FIG. 1 and FIG. 2, in this embodiment, the inner cross member 170 extends inward from the front frame 160 in the vehicle width direction, and the outer cross member 180 extends outward from the front frame 160 in the vehicle width direction. On the other hand, as shown in FIG. 3, in this embodiment, the inner reinforcing rib 220 extends inward from the rear region of the side frame 210 in the vehicle width direction, and the outer reinforcing rib 230 extends outward from the rear region of the side frame 210 in the vehicle width direction. Moreover, as shown in FIG. 1 and FIG. 2, in the cabin-interior region, the front frame 160, the inner cross member 170, and the outer cross member 180 form a triple fork structure 10. As shown in FIG. 3, in the cabin-exterior region, the inner reinforcing rib 220 and the outer reinforcing rib 230 form a double fork structure 20, and the inner cross member 170 and the inner reinforcing rib 220 are disposed to be opposite with intervention of the dashboard lower panel 110, and the outer cross member 180 and the outer reinforcing rib 230 are disposed to be opposite with intervention of the dashboard lower panel 110.

FIG. 1 to FIG. 3 merely illustrate the side member 140, the front pillar 150, the front frame 160, the inner cross member 170 and the outer cross member 180, the side frame 210, the inner reinforcing rib 220, and the outer reinforcing rib 230 on one side, but the side members 140, the front pillars 150, the front frames 160, the inner cross members 170 and the outer cross members 180, the side frames 210, the inner reinforcing ribs 220, and the outer reinforcing ribs 230 may be disposed in pairs on the left and right sides in the vehicle width direction.

In this way, when a vehicle to which the vehicle body structure 100 is applied collides, the collision load may be transmitted rearward via the side frame 210 disposed in front of the dashboard lower panel 110 through the front frame 160, and may be transmitted to the floor channel 130 and the side member 140 via the double fork structure 20 formed by the inner reinforcing rib 220 and the outer reinforcing rib 230 and the triple fork structure 10 formed by the front frame 160, the inner cross member 170 and the outer cross member 180 connected with the front frame 160, thereby spreading the impact of the collision load on the vehicle body structure 100.

More specifically, as shown in FIG. 1 to FIG. 4, in this embodiment, the vehicle body structure 100 is formed with the triple fork structure 10 in the cabin-interior region that forms the vehicle interior space for occupants to take seats, and is formed with the double fork structure 20 in the front compartment ER located in the cabin-exterior region. The triple fork structure 10 includes the front frame 160 as well as the inner cross member 170 and the outer cross member 180 respectively extending from the front frame 160 toward the inner side and the outer side in the vehicle width direction, and the double fork structure 20 includes the inner reinforcing rib 220 and the outer reinforcing rib 230 respectively extending from the rear region of the side frame 210 toward the inner side and the outer side in the vehicle width direction. Moreover, the vehicle body structure 100 has a configuration in which the inner cross member 170 of the triple fork structure 10 and the inner reinforcing rib 220 of the double fork structure 20 are disposed to be opposite with intervention of the dashboard lower panel 110 and the outer cross member 180 of the triple fork structure 10 and the outer reinforcing rib 230 of the double fork structure 20 are disposed to be opposite with intervention of the dashboard lower panel 110. Compared with the case in the conventional art where the dashboard lower panel 110 and the cross member form the load transmission path, the vehicle body structure 100, through the configuration of the triple fork structure 10 and the double fork structure 20, not only forms the load transmission path that transmits the collision load to the inner side and the outer side in the vehicle width direction through the triple fork structure 10 in the cabin-exterior region, but also form the load transmission path that transmits the load to the inner side and the outer side in the vehicle width direction through the double fork structure 20 in the cabin-exterior region. Accordingly, the area of the section for transmitting the collision load may be increased, and the load transmission performance at the time of collision is improved.

Furthermore, as shown in FIG. 1, in the triple fork structure 10 of this embodiment, the front frame 160 protrudes toward the cabin-interior region to form a central protrusion 161 extending along the vehicle length direction, the inner cross member 170 protrudes toward the cabin-interior region to the same extent as the central protrusion 161 to form an inner protrusion 171 extending inward and rearward in the vehicle width direction, the outer cross member 180 protrudes toward the cabin-interior region to the same extent as the central protrusion 161 to form an outer protrusion 181 extending outward and rearward in the vehicle width direction. When observed from the top, the central protrusion 161, the inner protrusion 171, and the outer protrusion 181 respectively extend toward different directions.

In this way, when a vehicle to which the vehicle body structure 100 is applied collides, the collision load transmitted from the side frame 210 to the front frame 160 may be transmitted rearward via the front frame 160, transmitted to the floor channel 130 via the inner cross member 170, and transmitted to the side member 140 via the outer cross member 180. The rear end parts of the front frame 160, the inner cross member 170, and the outer cross member 180 each extend toward different directions to form different directions of load transmission paths. That is, as shown in FIG. 1, the rear end part of the front frame 160 extends rearward, the inner cross member 170 extends inward in the vehicle width direction to the floor channel 130, and the rear end part of the outer cross member 180 extends outward in the vehicle width direction to the side member 140, thus allowing the collision load to be spread toward the directions of three load transmission paths. Moreover, through the configuration of the central protrusion 161 of the front frame 160, the inner protrusion 171 of the inner cross member 170, and the outer protrusion 181 of the outer cross member 180, the inner cross member 170 and the outer cross member 180 are both able to be joined with the front frame 160 in a wider range, thereby increasing the joining range. As a result, the overall rigidity is reinforced and the load transmission performance of each load transmission path is enhanced. Furthermore, since the central protrusion 161 of the front frame 160, the inner protrusion 171 of the inner cross member 170, and the outer protrusion 181 of the outer cross member 180 extend toward different directions respectively, when a collision occurs, the collision load transmitted from the side frame 210 to the front frame 160 may be appropriately transmitted and spread to a wide range in different directions (i.e., the directions of the three load transmission paths shown in FIG. 1).

Furthermore, as shown in FIG. 2 and FIG. 4, in this embodiment, the vehicle body structure 100 has a fixing bracket 191 above the triple fork structure 10, and the fixing bracket 191 is used to fix articles on the vehicle. In the upper region of the connection part where the side frame 210 and the front frame 160 are connected to each other through the dashboard lower panel 110, the fixing bracket 191 is connected to the front frame 160. Specifically, in this embodiment, the fixing bracket 191 is a component that supports an object (such as a brake booster) installed in the front compartment ER and fixes the object to the dashboard lower panel 110. Since the fixing bracket 191 has the strength and rigidity to support and fix a heavy object, the fixing bracket 191 is suitable for reinforcing the connection part that connects the front frame 160 and the side frame 210. In this way, when a collision occurs and the collision load is transmitted from the side frame 210 to the front frame 160, the fixing bracket 191 may be used to reinforce a thin plate structure of the dashboard lower panel 110 around the connection part.

Meanwhile, as shown in FIG. 3, when observed from a bottom view, in the double fork structure 20 of this embodiment, the inner reinforcing rib 220 and the outer reinforcing rib 230 each have different extension directions from the central protrude part 161 of the triple fork structure 10, and the inner reinforcing rib 220 and the outer reinforcing rib 230 form a fork part 240 exhibiting a fork shape at a position overlapping with the front frame 160 in the vehicle height direction. In this way, in the double fork structure 20, since the inner reinforcing rib 220 and the outer reinforcing rib 230 of the double fork structure 20 exhibits a fork shape at a position overlapping with the front frame 160 in the vehicle height direction, when a collision occurs, the collision load transmitted to the front frame 160 may also be appropriately transmitted from the front frame 160 in the cabin-interior region to the fork part 240 in the cabin-exterior region. Moreover, since the inner reinforcing rib 220 and the outer reinforcing rib 230 extend toward different directions respectively, the collision load transmitted from the front frame 160 to the fork part 240 may also be appropriately transmitted and spread to a wide range in different directions (i.e., the directions of the load transmission path shown in FIG. 3).

Moreover, unlike the dashboard lower panel 110, which is usually made of a thin plate, the vehicle body structure 100 may receive local reinforcement on regions on the load transmission path through adjustments to the plate thickness and the material rigidity of the outer reinforcing rib 230 and the inner reinforcing rib 220 of the double fork structure 20 located in the cabin- exterior region, and selection of plate thickness and materials based on the requirements of regions that need reinforcement,. In this way, when encountering a severe collision situation, a larger collision load may also be transmitted through reinforcement of the double fork structure 20 without having to reinforce the entire vehicle body structure 100, thereby reducing product costs and weight at the same time.

Furthermore, as shown in FIG. 5, in this embodiment, the vehicle body structure 100 has a central section CCS formed by the front frame 160 and the dashboard lower panel 110, and a power unit IPU is provided in a region behind the double fork structure 20 and below the central section CCS. Conventionally, in general, the power unit IPU is mostly located below the floor panel 120. However, in this embodiment, the region below the central section CCS formed by the front frame 160 and the dashboard lower panel 110 may also serve as a region for arranging the power unit IPU.

This is because, in the front compartment ER located in the cabin-exterior region, the vehicle body structure 100 does not have a component corresponding to the front reinforcing rib of the front frame 160. Thus, when a collision occurs, the collision load is only transmitted at the parts of the inner reinforcing rib 220 and the outer reinforcing rib 230. Therefore, in this embodiment, when the configuration space of the power unit IPU is expanded and moved forward to below the dashboard lower panel 110, the vehicle body structure 100 may also prevent the collision load from being transmitted to the power unit IPU during the collision process, which is favorable for increasing the degree of freedom of the configuration space of the power unit IPU.

Moreover, as shown in FIG. 4 and FIG. 6, in this embodiment, the vehicle body structure 100 further includes an abutting component 192, the abutting component 192 protrudes toward the cabin-interior region and is disposed to span across the inner protrusion 171 of the inner cross member 170 in the vehicle length direction, the abutting component 192 is configured above a closed section CSI2 formed by the inner reinforcing rib 220 and the dashboard lower panel 110. Specifically, in this embodiment, the abutting component 192 is an abutting bracket for the driver to place the right foot and is located above the closed section CSI2 formed by the inner reinforcing rib 220 and the dashboard lower panel 110. Therefore, when the abutting component 192 is disposed at a position where the strength and rigidity are enhanced due to the configuration of the closed section CSI2 formed by the inner reinforcing rib 220 and the dashboard lower panel 110, the noise, vibration and harshness (NVH) performance of the abutting component 192 may thereby be enhanced.

On the other hand, as shown in FIG. 4, in this embodiment, the inner cross member 170 further includes a channel connection part 172 and a flange connection part 173. The channel connection part 172 is connected to a side surface part 131 of the floor channel 130, the flange connection part 173 is connected to the floor channel 130 and the dashboard lower panel 110, and in the rear region of the inner protrusion 171 of the inner cross member 170, the channel connection part 172 and the flange connection part 173 form an L-shaped section. In this way, since the channel connection part 172 and the flange connection part 173 are connected to form an L-shaped section, when a collision occurs, the collision load transmitted from the inner cross member 170 to the floor channel 130 may be appropriately transmitted to the L-shaped section of the inner cross member 170 and transmitted through a ridge part 133 where the side surface part 131 and a flange part 132 of the floor channel 130 intersect.

Furthermore, as shown in FIG. 6, in this embodiment, the closed section CSI1 formed by the inner protrusion 171 of the inner cross member 170 and the dashboard lower panel 110 and the closed section CSI2 formed by the inner reinforcing rib 220 and the dashboard lower panel 110 are configured to be staggered in the vehicle length direction. In this way, through the structure where the closed section CSI1 formed by the inner protrusion 171 and the dashboard lower panel 110 in the cabin-interior region and the closed section CSI2 formed by the inner reinforcing rib 220 and the dashboard lower panel 110 in the cabin-exterior region are staggered in the vehicle length direction, the load may be transmitted to a wide range of the floor channel 130.

On the other hand, as shown in FIG. 7, in this embodiment, a closed section CSO1 formed by the outer protrusion 181 and the dashboard lower panel 110 and a closed section CSO2 formed by the outer reinforcing rib 230 and the dashboard lower panel 110 are disposed to be opposite to each other, thereby forming an outer closed section OCS. In this way, through the configuration where the closed sections formed by the outer protrusion 181 in the cabin-interior region and the outer reinforcing rib 230 in the cabin-exterior region are disposed to be opposite to each other to form the outer closed section OCS, the collision load may be appropriately transmitted to the vehicle body frame including the side member 140 and the front pillar 150 on the vehicle outer side.

Furthermore, in this embodiment, the outer cross member 180 further includes a front connection part 182, a bent protrusion 183, and a rear connection part 184. The front connection part 182 is a part where the outer protrusion 181 is connected to at least one of the side member 140 and the front pillar 150. The bent protrusion 183 extends from the center of the outer protrusion 181 in the vehicle width direction along the vehicle length direction, and the rear region of the bent protrusion 183 bends toward the side member 140. The rear connection part 184 extends from the bent protrusion 183 toward the side surface of the side member 140 and connects. In this way, when a collision occurs, the collision load transmitted to the outer cross member 180 may be transmitted through the outer protrusion 181 and via the front connection part 182. In addition, through the configuration of the bent protrusion 183 and the rear connection part 184, the collision load may be transmitted and spread to a larger region of the side member 140.

Furthermore, in Patent Document 1 (Chinese Patent Publication No. 118457737), the closed section for transmitting the collision load in the outer cross member of Patent Document 1 is formed by an upper section part and a lower section part that are each configured as a closed section with a cover-like structure and arranged in parallel. Therefore, when a collision occurs, the collision load transmitted to the outer cross member of Patent Document 1 is equally transmitted to the upper part and lower part of the closed section of the outer cross member. Comparatively, the outer cross member 180 of this embodiment may be distinguished into a closed section formed by the outer protrusion 181 and a closed section formed by the bent protrusion 183, where the closed section formed by the outer protrusion 181 may serve as a main load transmission path, and the bent protrusion 183 may match and correspondingly control the magnitude of collision load transmission through the degree of bending, thereby reliably transmitting the collision load and causing the collision load to be spread to a larger region.

Based on the above, in the embodiment of the disclosure, the vehicle body structure is provided with a triple fork structure in the cabin-interior region that forms the vehicle interior space where the occupants take seats, and is provided with a double fork structure in the front compartment located in the cabin-exterior region. The triple fork structure includes the front frame and the inner cross member and the outer cross member that extend inward and outward respectively from the front frame in the vehicle width direction, and the double fork structure includes the inner reinforcing rib and the outer reinforcing rib that extend inward and outward respectively from a rear region of the side frame in the vehicle width direction. Moreover, through the configuration where the inner cross member of the triple fork structure and the inner reinforcing rib of the double fork structure are disposed to be opposite with intervention of the dashboard lower panel and the outer cross member of the triple fork structure and the outer reinforcing rib of the double fork structure are disposed to be opposite with intervention of the dashboard lower panel, compared with the structure of the section formed by the dashboard lower panel and the cross member as the load transmission path in the prior art, the vehicle body structure may adopt the sections formed by the triple fork structure and the double fork structure as the load transmission paths, thereby increasing the area of the section for transmitting the collision load and improving the load transmission performance at the time of collision. Furthermore, unlike the conventional dashboard lower panel made of a thin plate, in the vehicle body structure of the disclosure, the plate thickness and the material rigidity of the outer reinforcing rib and inner reinforcing rib of the double fork structure located in the cabin-exterior region may be adjusted, and the plate thickness and the materials may be selected based on the requirements of regions that need reinforcement, thereby enabling local reinforcement on regions of the load transmission path. In this way, when encountering a severe collision situation, the requirement for transmitting a larger collision load may also be realized through the double fork structure without having to reinforce the entire vehicle body structure, and the needs for reducing the product cost and weight can be addressed at the same time.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A vehicle body structure, comprising: a dashboard lower panel, disposed on a front end side of the vehicle body structure and partitioning a cabin-interior region and a cabin-exterior region of a compartment; a side frame, extending along a vehicle length direction in a front compartment located in the cabin-exterior region; a front frame, disposed in the cabin-interior region to be opposite to a rear region of the side frame with intervention of the dashboard lower panel, and extending in the vehicle length direction along the dashboard lower panel; an inner cross member, extending inward from the front frame in a vehicle width direction; an outer cross member, extending outward from the front frame in the vehicle width direction; an inner reinforcing rib, extending inward from the rear region of the side frame in the vehicle width direction; and an outer reinforcing rib, extending outward from the rear region of the side frame in the vehicle width direction, wherein in the cabin-interior region, the front frame, the inner cross member, and the outer cross member form a triple fork structure, in the cabin-exterior region, the inner reinforcing rib and the outer reinforcing rib form a double fork structure, and the inner cross member and the inner reinforcing rib are disposed to be opposite via the dashboard lower panel, and the outer cross member and the outer reinforcing rib are disposed to be opposite with intervention of the dashboard lower panel.

2. The vehicle body structure as claimed in claim 1, further comprising: a central section formed by the front frame and the dashboard lower panel, wherein a power unit is provided in a region behind the double fork structure and below the

3. The vehicle body structure as claimed in claim 1, wherein in the triple fork structure, the front frame protrudes toward the cabin-interior region to form a central protrusion extending along the vehicle length direction, the inner cross member protrudes toward the cabin-interior region to a same extent as the central protrusion and forms an inner protrusion extending inward and rearward along the vehicle width direction, the outer cross member protrudes toward the cabin-interior region to a same extent as the central protrusion and forms an outer protrusion extending outward and rearward along the vehicle width direction, and when observed from a top perspective, the central protrusion, the inner protrusion, and the outer protrusion extend in different directions, respectively.

4. The vehicle body structure as claimed in claim 3, in the vehicle body structure as claimed in wherein when viewed from a bottom perspective, in the double fork structure, the inner reinforcing rib and the outer reinforcing rib and the central protrusion of the triple fork structure extend in different directions, respectively, and the inner reinforcing rib and the outer reinforcing rib form a fork part exhibiting a fork shape at a position overlapping with the front frame in a vehicle height direction.

5. The vehicle body structure as claimed in claim 3, further comprising: a floor panel, connected to a rear end of the dashboard lower panel; and
a floor channel, disposed at a center of the dashboard lower panel and the floor panel in the vehicle width direction and extending along the vehicle length direction, the inner cross member comprises a channel connection part and a flange connection part, the channel connection part is connected to a side surface part of the floor channel, the flange connection part is connected to the floor channel and the dashboard lower panel,

6. The vehicle body structure as claimed in claim 3, wherein a closed section formed by the inner protrusion and the dashboard lower panel and a closed section formed by the inner reinforcing rib and the dashboard lower panel are disposed to be staggered in the vehicle length direction.

7. The vehicle body structure as claimed in claim 6, further comprising: an abutting component, protruding toward the cabin-interior region, wherein the abutting component is disposed to span across the inner protrusion in the vehicle length direction, and the abutting component is disposed above the closed section formed by the inner reinforcing rib and the dashboard lower panel.

8. The vehicle body structure as claimed in claim 3, wherein a closed section formed by the outer protrusion and the dashboard lower panel and a closed section formed by the outer reinforcing rib and the dashboard lower panel are disposed to be opposite to each other to form an outer closed section.

9. The vehicle body structure as claimed in claim 3, further comprising: a side member, extending along the vehicle length direction; and a front pillar, extending upward from a front end of the side member, wherein the outer cross member further comprises: a front connection part, arranged as a portion of the outer protrusion connected to at least one of the side member and the front pillar; a bent protrusion, extending from a center of the outer protrusion in the vehicle width direction along the vehicle length direction, wherein a rear region of the bent protrusion is bent toward the side member; and a rear connection part, extending from the bent protrusion toward and be connected to a side surface of the side member.

10. The vehicle body structure as claimed in claim 1, further comprising: a fixing bracket, provided above the triple fork structure and configured to fix articles on a vehicle, wherein, in an upper region of a connection part where the side frame and the front frame are connected to each other via the dashboard lower panel, the fixing bracket and the front frame are connected.
